(19) United States
(12) Patent Application Publication
(10) Pub. No.: US 2019/0340264 A1
(43) Pub. Date: Nov. 7, 2019

(54) DATA EXCHANGE GROUP SYSTEM AND A METHOD THEREOF

(71) Applicant: WALTON ADVANCED ENGINEERING INC., Kaohsiung (TW)

(72) Inventors: Hong Chi YU, Kaohsiung (TW); Mao Ting CHANG, Kaohsiung (TW)

(73) Assignee: WALTON ADVANCED ENGINEERING INC., Kaohsiung (TW)

(21) Appl. No.: 16/019,601

(22) Filed: Jun. 27, 2018

(30) Foreign Application Priority Data
May 3, 2018 (TW) 107115034

(51) Int. Cl. G06F 17/30

(52) U.S. Cl. CPC G06F 17/30165; G06F 17/30132; G06F 17/30227

(57) ABSTRACT

The present disclosure relates to a data exchange group system and a method thereof which features: a shared file is saved in a file storage space of a storage device via the internet and also recorded in an intrinsic file list of the storage device; the shared file is configured to be shared in the storage device and also recorded in a shared file list of the storage device; the shared file is configured to be queried in a transaction system and recorded in a group file list of the storage device; the shared file encrypted and authorized in the transaction system is received by a data recipient through an encrypted file connection for the shared file of the storage device.

### BACKGROUND OF THE INVENTION

### 1) Field of the Invention

The present disclosure relates to a data exchange group system and a method thereof, particularly a system for file transactions featuring a complete shared file list protected by the blockchain technology, a shared file not checked by a server, encrypted information stored in a cache section for fast sharing, and a file shared to data receivers offline.

### 2) Description of the Prior Art

In recent years, individual electronic equipment popular with the general public makes users, who are unfamiliar with knowledge of cyber security mostly, develop the habit of relying on all types of user-friendly electronic devices in which various personal information and/or messages are left precariously but disregard individual privacy.

To store all kind of information in electronic equipment safely, the authentication methods as major mechanisms of ensuring personal privacy, for example, username/password, one-time password, and physical authentication key, have been available; additionally, the pairing methods as minor mechanisms of ensuring access to an electronic device by another user but preventing electronic equipment from any unauthorized user's invasion can be Wi-Fi protecting configurations, Bluetooth pairing, etc.

On the other hand, the issue for the copyright of a shared file should be considered, for example, film clip and background music for legitimate usage.

There have been several patents for data sharing or authentication as shown below.

A data exchange guidance device and a method thereof is disclosed in Paten/Publication Number TW 106135659 of the Intellectual Property Office, MOEA, R.O.C. When an interface of the data exchange guidance device is electrically connected to an electronic device by a user, a processing program is executed for reading private key information, accessing a remote shared information list on the internet through the electronic device, and displaying the remote shared information list on a graphical interface; moreover, when the electronic device at the interface of the data exchange guidance device is connected to a virtual network card for executing the processing program, private key information is read by the processing program and the remote shared information list is accessed by the processing program through the virtual network card and displayed on a graphical interface.

As disclosed in Paten/Publication Number TW 583539 of the Intellectual Property Office, MOEA, R.O.C., an internet-based document management system and a method of providing internet-based document management feature an access token controlling accesses to and services in the Internet-based document management system. The Internet-based document management system allows an electronic document to be saved in the network-accessible server, accessed through an internet browser known to the public, downloaded for reading and operations, and returned to the server for accesses of other users. The server is a programmable device which creates and verifies a valid access token and provides a plurality of services supported by a public database and a document storage device such as storage and access service, electronic document delivery service, document distribution service, file sharing service and workflow service. Preferably, the internet-based document management system is characteristic of a security function, a filtering function and a booking function due to programmability for detailed transactions made in the internet-based document management system as well as other customized functions for common document management services inside a server shared to multiple service providers and separate & specific websites available to end users.

As disclosed in Paten/Publication Number TW M557423 of the Intellectual Property Office, MOEA, R.O.C., a big-data transaction platform for matchmaking and instant notification of building material business is characteristic of a big database in the clouds in which building material information from suppliers are saved and a matchmaking platform connected to the big database and configured by a user for matching conditions of building materials as required such that a matchmaking process for the big database is enabled in the matchmaking platform and ranks are saved in a storage space of the matchmaking platform login by users and browsed and accessed by users for any transaction; moreover, messages of contact information of users, who accessed the matchmaking platform for downloads, caught by the matchmaking platform or an administrator will be delivered to building material suppliers for a higher matchmaking rate.

In the current trend, data/file sharing methods diversified and complicated continuously must confirm to data/file sharing without divulgence risks and copyright issues for least idle time of a data receiver.

Accordingly, a data exchange group system and a method thereof is provided in the present disclosure to settle the above issues.

### SUMMARY OF THE INVENTION

In virtue of the above problem, a data exchange group system and a method thereof rely on the blockchain technology to create a shared file list and ensure reliability of the shared file list.

A data exchange group system and a method thereof in the present disclosure reduce costs estimated for files shared in a server and clarify responsibilities with respect to file sharing.

A data exchange group system and a method thereof in the present disclosure features a transaction system with which pecuniary exchanges derived from data exchanges are simplified.

A data exchange group system and a method thereof in the present disclosure make use of a cache file section in which a file configured to be shared is saved temporarily.

A data exchange group system and a method thereof in the present disclosure depend on an encryption key to ensure a shared file not peeped covertly, partitioning a storage device itself for safety of the encryption key.

To this end, the present application adopts the following technical measures. The present disclosure relates to a data exchange group system comprising: at least two storage devices, each of which comprises a network module, an encryption key, a file storage space, an intrinsic file list, a shared file list and a group file list wherein a shared file is recorded in the file storage space for production of an encrypted file connection and a decryption key, the intrinsic file list is a file directory of all files saved in the file storage space, the shared file list is a file directory of files in the file storage space to be shared, the group file list for the shared file lists of the storage devices is created by the blockchain technology, and the file storage space is a data space in which data is saved with the encryption key; a transaction system, which comprises the group file list and a transaction interface; a data exchange group system is characterized that the shared file encrypted and authorized in the transaction system is received through the encrypted file connection for the shared file of the storage device and decrypted with the decryption key.

A data exchange group system is further embodied according to the following technical measure.

In the data exchange group system, the decryption key is produced with the encryption key and the shared file.

In the data exchange group system, the transaction system comprises a group provisional list corresponding to the storage device for the encrypted file connection temporarily.

In the data exchange group system, the transaction system comprises a cache file section in which the encrypted shared file is saved temporarily.

Furthermore, to this end, a method of a data exchange group system is embodied according to another technical measure as follows. A method of a data exchange group system in the present disclosure comprises steps as follows: step 1, a shared file is saved in a file storage space of a storage device via the internet and also recorded in an intrinsic file list of the storage device; step 2, the shared file is configured to be shared in the storage device and also recorded in a shared file list of the storage device; step 3, the shared file is configured to be queried in a transaction system and recorded in a group file list of the storage device; step 4, the shared file encrypted and authorized in the transaction system is received by a data recipient through an encrypted file connection for the shared file of the storage device.

A method of a data exchange group system is further embodied according to the following technical measure.

The method of a data exchange group system comprises a step in which the shared file is configured to be saved in or not saved in a cache file section of the transaction system temporarily after step 2.

The method of a data exchange group system comprises a step in which the shared file is queried through a transaction interface of the transaction system after step 3.

The method of a data exchange group system comprises a step in which the encrypted shared file is obtained from a cache file section of the transaction system after step 4.

The method of a data exchange group system comprises a step in which the shared file configured to be not queried in a transaction system in step 3 is recorded in a group provisional list of the transaction system.

The method of a data exchange group system comprises a step in which the encrypted shared file is decrypted with a decryption key obtained previously after step 4.

In contrast to the prior art, a data exchange group system and a method thereof in the present disclosure feature effects as follows: (1) a shared file list is created by the blockchain technology which ensures reliability of the shared file list; (2) costs estimated for files shared in a server are reduced and responsibilities with respect to file sharing are clarified in virtue of an encryption mechanism; (3) pecuniary exchanges derived from data exchanges are simplified for high privacy.

### BRIEF DESCRIPTIONS OF THE DRAWINGS

FIG. 1 is the first schematic view of a data exchange group system and a method thereof in a preferred embodiment.

FIG. 2 is the second schematic view of a data exchange group system and a method thereof in a preferred embodiment.

FIG. 3 is the third schematic view of a data exchange group system and a method thereof in a preferred embodiment.

FIG. 4 is the first flowchart of a data exchange group system and a method thereof in a preferred embodiment.

FIG. 5 is the second flowchart of a data exchange group system and a method thereof in a preferred embodiment.

### DETAILED DESCRIPTIONS OF THE PREFERRED EMBODIMENTS

A data exchange group system and a method thereof are further illustrated in preferred embodiments for clear understanding of purposes, characteristics and effects:

FIGS. 1, 2 and 4 illustrate a data exchange group system and a method thereof in the first embodiment; as shown in FIG. 1, a data exchange group system in the present disclosure comprises at least two storage devices (10, 10′) and a transaction system (20)

In the data exchange group system, the storage device (10) comprises a network module (11), an encryption key (12), a file storage space (13), an intrinsic file list (14), a shared file list (15), a group file list (16) and a shared file (17).

In practice, the network module (11) is an assembly through which a network connection function is provided, for example, a network interface controller (NIC) as hardware designed for communications, wired or wireless, of a computer on the internet; furthermore, the encryption key (12) is hidden data such that files are irreproducible; the encryption key (12) means an encrypted private key based on the public-key cryptography through which two keys, a public key and a private key, are demanded; the public key (the private key) is available to encrypting (decrypting) a plaintext (ciphertext) or decrypting (encrypting) a ciphertext (plaintext). A cryptograph which has been encrypted with a key must be decrypted with the other corresponding key for a readable plaintext. A key which is correlated with the other corresponding key mathematically and available supposedly cannot be taken as a basis to estimate the corresponding key.

Moreover, the file storage space (13) is created in a device in which digitalized data and/or media are stored electrically, magnetically or optically, for example, a Hard Disk Drive (HDD) that is a non-volatile storage device based on solid rotary discs and common in a computer; the file storage space (13) is a data space for storage of encrypted data by the encryption key (12); the intrinsic file list (14) illustrates a file directory or a data directory for recording all files and/or data inside the file storage space (13) effectively; the shared file list (15), which is a file directory or a data directory for recording files and/or data in the file storage space (13) to be shared, comprises information of an encrypted file connection (171) and a decryption key (172); the group file list (16), which comprises the shared file lists (15, 15′) of the storage devices (10, 10′), is created through the blockchain technology; the shared file (17), which means a data set to be shared, is recorded and saved in the file storage space (13) for creation of an encrypted file connection (171) and a decryption key (172) wherein the encrypted file connection (171) means a URL (uniform resource locator) for the encrypted shared file (17) to be downloaded and the decryption key (172) created for the encryption key (12) as well as the shared file (17) is a public key based on public-key cryptography, matching the encryption key (12) as a private key, and produced for sharing of a file.

In addition, the blockchain technology is a technical solution for storage, verification, transmission and communication of network data through intrinsic distributed nodes rather than the any third party. In an existing blockchain system, each user has a change to create data logs. Any data change within a period of time can be recorded by anyone in the blockchain system for production of an individual's complete data log. Relying on the ingenious distributed algorithm cryptographically and mathematically, the blockchain technology, which has been considered as a most disruptive technology innovation since invention of the internet, allows consensus to be reached by internet users, who failed to create trust relationships with one another, without intervention of any third party for effectuating reliable delivery of trust and value at a low cost.

In the data exchange group system, the transaction system (20) comprises the group file list (16) and a transaction interface (21).

In practice, the transaction system (20), which is a system for network information queries and transaction services on the internet, is provided with the transaction interface (21), a graphic user interface for simplified man-machine interactions available to users, such that the shared file lists (15, 15′) of the storage devices (10, 10′) in the group file list (16) are searched for sharing and micro-transaction within a group; any transaction service above mentioned is confirmed through ordinary third party verification/payment with which a transaction result is returned.

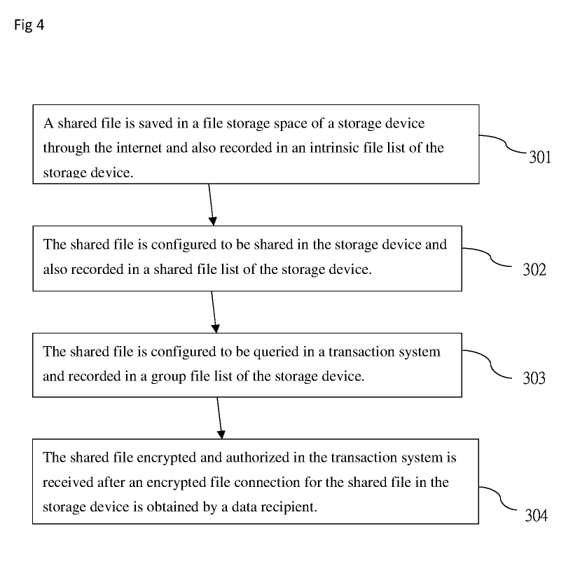

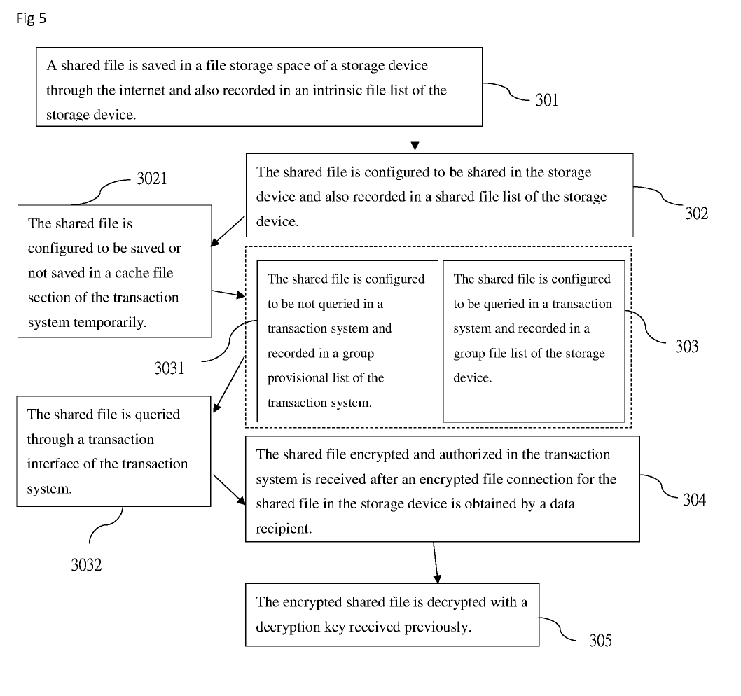

The following sections are introductions to a method of a data exchange group system, as shown in FIG. 4 for step 1 (301), step 2 (302), step 3 (303) and step 4 (304).

As shown in step 1 (301) in FIGS. 1 and 4, a shared file (17) is saved in a file storage space (13) of a storage device (10) via the internet and also recorded in an intrinsic file list (14) of the storage device (10).

In detail, a storage device (10), a storage device (10′) and a transaction system (20) are connected to and communicate with one another via the internet for a synchronized group file list (16); a shared file (17), which has been encrypted with an encryption key (12), is saved in the file storage space (13) of the storage device (10) through the network module (11) by a data owner (40) and recorded in an intrinsic file list (14) of the storage device (10) for completion of a data log.

Then, as shown in step 2 (302) in FIGS. 1 and 4, the shared file (17) is configured to be shared in the storage device (10) and recorded in a shared file list (15) of the storage device (10).

In practice, the shared file (17) in step 2 (302) is shared in the storage device (10) by a data owner (40), who configured a file to be shared, and recorded in the shared file list (15) of the storage device (10) for completion of a data log with respect to sharing a file in the storage device (10); then, an encrypted file connection (171) and a decryption key (172) are created based on the shared file (17) wherein the encrypted file connection (171) is used to download the shared file (17).

As shown in step 3 (303) in FIGS. 1 and 4, the shared file is configured to be queried in a transaction system (20) and recorded in a group file list (16) of the storage device (10).

In practice, a file is configured to be queried in the transaction system (20) by a data owner (40) in step 3 (303); a file, which is allowed to be queried in the transaction system (20), should be recorded in the group file list (16) of the storage device (10) for completion of a data log with respect to querying and sharing a file in the storage device (10).

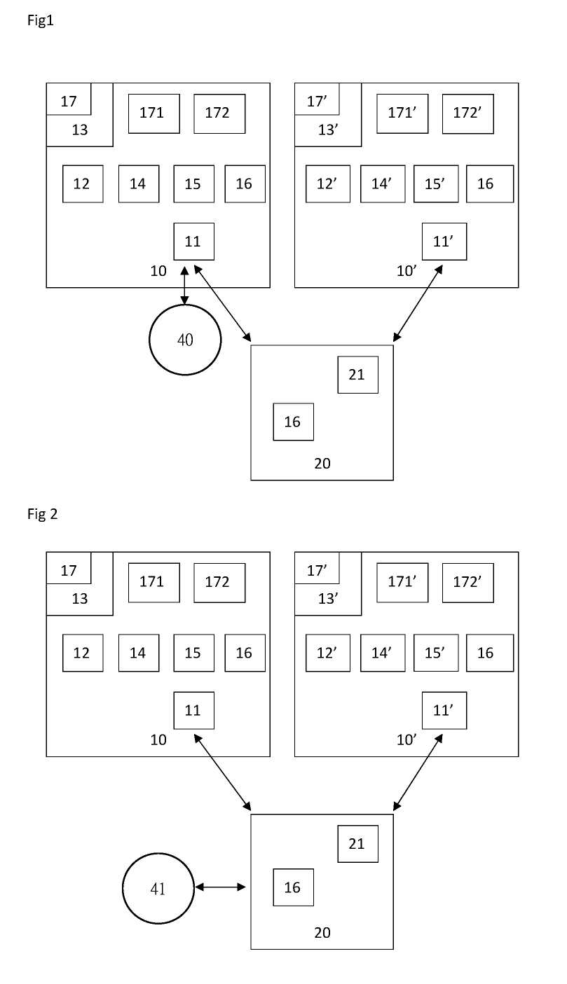

As shown in step 4 (304) in FIGS. 2 and 4, the shared file (17) encrypted and authorized in the transaction system (20) is received by a data recipient (41) who has accessed an encrypted file connection (171) for the shared file (17) of the storage device (10).

In general, the encrypted file connection (171) is known to a data recipient (41) who searched a shared file in the transaction system (20); moreover, the shared file (17) is received by a data recipient (41) who is charged for the online access of the shared file (17) in the transaction system (20).

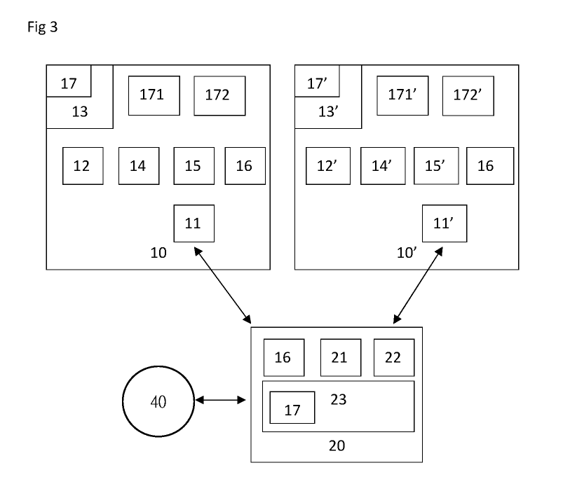

Referring to FIGS. 3 and 5, which illustrate a data exchange group system and a method thereof in the second embodiment in which the symbols identical to those of the first embodiment in FIGS. 1, 2 and 4 are not explained hereinafter. The differences in the second embodiment differing from the first embodiment are more steps as follows: step 2-1 (3021) between step 2 (302) and step 3 (303); step 3-5 (3032) between step 3 (303) and step 3 (304); step 5 (305); step 3-1 (3031) along with step 3 (303) of the first embodiment.

Referring to FIG. 3 for the second embodiment which presents some features different from those in the first embodiment as follows: the transaction system (20) comprises a group provisional list (22) corresponding to a storage device (10) of the encrypted file connection (171) temporarily and being differentiated from the group file list (16) because specific files shared by the storage devices (10, 10′) and recorded in the group provisional list (22) is not queried by any unauthorized user through the transaction interface (21); the encrypted file connection (171) comprises information related to the group provisional list (22) and a file authorized in the transaction system (20) is accessed through a corresponding storage device (10) optionally; the transaction system (20) comprises a cache file section (23) in which the encrypted shared file (17) is saved temporarily such that a data exchange or a fast peer-to-peer file exchange is activated between the storage devices (10, 10′) offline.

A method of a data exchange group system is introduced as follows. Referring to FIG. 5, which illustrates step 1 (301), step 2 (302), step 2-1 (3021), step 3 (303), step 3-1 (3031), step 3-2 (3032), step 4 (304) and step 5 (305).

As shown in step 1 (301) in FIGS. 1 and 5, a storage device (10), a storage device (10′) and a transaction system (20) are connected to and communicate with one another via the internet for a synchronized group file list (16); in step 1 (301), a shared file (17) is saved in a file storage space (13) of a storage device (10) through the internet and also recorded in an intrinsic file list (14) of the storage device (10).

Then, as shown in step 2 (302) in FIGS. 1 and 5, the shared file (17) is configured to be shared in the storage device (10) and also recorded in a shared file list (15) of the storage device (10).

Furthermore, as shown in step 2-1 (3021) in FIGS. 1, 3 and 5, the shared file (17) is configured to be saved or not saved in a cache file section (23) of the transaction system (20) temporarily.

In detail, the shared file (17), which has been configured to be saved in a cache file section (23) of the transaction system (20) temporarily and encrypted, should be uploaded to the cache file section (23) such that a data exchange or a fast peer-to-peer file exchange is activated between the storage devices (10, 10′) offline.

Then, as shown in step 3 (303) in FIGS. 1, 3 and 5, the shared file is configured to be queried in a transaction system (20) and recorded in a group file list (16) of the storage device (10); otherwise, the shared file is configured to be not queried in a transaction system (20) and recorded in a group provisional list (22) of the transaction system (20).

In practice, a file is configured to be queried in the transaction system (20) and shared by a data owner (40) optionally in step 3 (303); a file, which is allowed to be queried in the transaction system (20), should be recorded in the group file list (16) of the storage device (10) for completion of a data log with respect to querying and sharing a file in the storage device (10). When a shared file (17) is configured to be not queried in the transaction system (20) in step 3 (303), the transaction system (20) provides an alternative function that the shared file (17) is downloaded via the encrypted file connection (171) and recorded in a group provisional list (22) of the transaction system (20) in step 3-1 (3031).

As shown in step 3-2 (3032) in FIGS. 3 and 5, the shared file (17) is shared after the query operation through a transaction interface (21) of the transaction system (20); the shared file (17) which has been configured to be queried in a transaction system (20) in step 3 (303) is shared.

Then, as shown in step 4 (304) in FIGS. 3 and 5, the shared file (17) encrypted and authorized in the transaction system (20) is received after an encrypted file connection (171) for the shared file (17) in the storage device (10) is obtained by a data recipient (41).

Finally, as shown in step 5 (305) in FIGS. 3 and 5, the encrypted shared file (17) is decrypted with a decryption key (172) received previously.

In general, both the encrypted file connection (171) and the decryption key (172) authorized by the transaction system (20) are obtained by a data recipient (41) after payment; in practice, both the encrypted file connection (171) and the decryption key (172) are integrated for generation of a URL such that a shared file (17) is received by a data recipient (41) conveniently.

Referring to FIGS. 1, 3 and 5, which illustrate a real case of effectuating descriptions mentioned in previous sections.

As shown in FIG. 1, a storage device (10), a storage device (10′) and a transaction system (20) are connected to and communicate with one another via the internet for a synchronized group file list (16); a shared file (17) uploaded to a storage device (10) through a network module (11) by a data owner (40) is encrypted with an encryption key (12), saved in a file storage space (13) and recorded in an intrinsic file list (14) of the storage device (10) for completion of a data log with respect to sharing a file in the storage device (10); moreover, another shared file (17′) was saved in a file storage space (13′) of another storage device (10′) and recorded in the group file list (16) in advance.

Then, an encrypted file connection (171) and a decryption key (172) are created according to the shared file (17), which has been shared in the storage device (10) by the data owner (40) and recorded in a shared file list (15) for completion of a data log with respect to sharing a file in the storage device (10); as shown in FIG. 3, the shared file (17) configured to be saved in a cache file section (23) of the transaction system (20) temporarily is encrypted and uploaded to the cache file section (23) for a data exchange or a fast peer-to-peer file exchange between the storage devices (10, 10′) offline; meanwhile, both the encrypted file connection (171) and the decryption key (172) are obtained by the data owner (40).

Furthermore, the shared file (17) configured to be not queried in the transaction system (20) by the data owner (40) is not recorded in the group file list (16) of the storage device (10); however, the shared file (17) can be downloaded and further recorded in a group provisional list (22) of the transaction system (20) based on an alternative function of the encrypted file connection (171) authorized by the transaction system (20) wherein the group provisional list (22) comprises information of the encrypted file connection (171) and the decryption key (172); additionally, the shared file (17′) configured to be queried and shared in the transaction system (20) in advance is recorded in the group file list (16) of the storage device (10′).

Next, as shown in FIG. 3, the shared file (17) encrypted and authorized in the transaction system (20) is received by a data recipient (41) who depends on an encrypted file connection (171) of the shared file (17) given to the storage device (10) by the data owner (40); moreover, an encrypted file connection (171′) of the shared file (17′) which was found from the group file list (16) via a transaction interface (21) of the transaction system (20) is obtained by the data recipient (41).

Finally, the encrypted shared file (17) is decrypted with the decryption key (172) by the data recipient (41), who depends on a URL including the encrypted file connection (171) and the decryption key (172) given by the data owner (40) and incorporated with each other, in practice; moreover, the encrypted shared file (17′) is decrypted with the encrypted file connection (171′) and the decryption key (172′), both of which are authorized by the transaction system (20) and obtained by the data recipient (41) after payment.

Accordingly, a data exchange group system and a method thereof which differ from a conventional data exchange device and a method thereof are referred to as creative work in the data exchange technique meets patentability and is applied for the patent.

It should be reiterated that the above descriptions present the preferred embodiment, and any equivalent change in specifications, claims or drawings still belongs to the technical field within the present disclosure with reference to claims hereinafter.

What is claimed is:

1. A data exchange group system, comprising:
at least two storage devices, each of which comprises a network module, an encryption key, a file storage space, an intrinsic file list, a shared file list and a group file list wherein a shared file is recorded in the file storage space for production of an encrypted file connection and a decryption key, the intrinsic file list is a file directory of all files saved in the file storage space, the shared file list is a file directory of files in the file storage space to be shared, the group file list for the shared file lists of the storage devices is created by the blockchain technology, and the file storage space is a data space in which data is saved with the encryption key;
a transaction system, which comprises the group file list and a transaction interface;
characterized that the shared file encrypted and authorized in the transaction system is received through the encrypted file connection for the shared file of the storage device and decrypted with the decryption key.

2. The data exchange group system as claimed in claim 1 wherein the decryption key is produced with the encryption key and the shared file.

3. The data exchange group system as claimed in claim 1 wherein the transaction system comprises a group provisional list corresponding to the storage device for the encrypted file connection temporarily.

4. The data exchange group system as claimed in claim 1 wherein the transaction system comprises a cache file section in which the encrypted shared file is saved temporarily.

5. A method of a data exchange group system, comprising steps as follows:
step 1: a shared file is saved in a file storage space of a storage device via the internet and also recorded in an intrinsic file list of the storage device;
step 2: the shared file is configured to be shared in the storage device and also recorded in a shared file list of the storage device;
step 3: the shared file is configured to be queried in a transaction system and recorded in a group file list of the storage device;
step 4: the shared file encrypted and authorized in the transaction system is received by a data recipient through an encrypted file connection for the shared file of the storage device.

6. The method of a data exchange group system as claimed in claim 5 wherein the shared file is configured to be saved in or not saved in a cache file section of the transaction system temporarily after step 2.

7. The method of a data exchange group system as claimed in claim 5 wherein the shared file configured to be not queried in a transaction system in step 3 is recorded in a group provisional list of the transaction system

8. The method of a data exchange group system as claimed in claim 5 wherein the shared file is queried through a transaction interface of the transaction system after step 3.

9. The method of a data exchange group system as claimed in claim 5 wherein the encrypted shared file is obtained from a cache file section of the transaction system after step 4.

10. The method of a data exchange group system as claimed in claim 5 wherein the encrypted shared file is decrypted with a decryption key obtained previously after step 4.
